(19) United States
(12) Patent Application Publication
(10) Pub. No.: US 2015/0151496 A1
(43) Pub. Date: Jun. 4, 2015

(54) PUL-CORE METHOD WITH A PMI FOAM CORE

(71) Applicants: Evonik Industries AG, Essen (DE); Secar Technologie GmbH, Muezzuschlag-Hoenigsberg (AT)

(72) Inventors: Arnim Kraatz, Darmstadt (DE); Karl-Heinz Semlitsch, Muerzzuschlag (AT)

(73) Assignees: Evonik Industries AG, Essen (DE); Secar Technologie GmbH, Muerzzuschlag-Hoenigsberg (AT)

(21) Appl. No.: 14/402,446

(22) PCT Filed: May 13, 2013
(86) PCT No.: PCT/EP2013/059756

§ 371 Date: Nov. 20, 2014

(30) Foreign Application Priority Data
May 21, 2012 (DE) 10 2012 208 428.2

(51) Int. Cl. B29C 70/52; B32B 5/24; B32B 1/00

(52) U.S. Cl. CPC B29C 70/521; B32B 1/00; B32B 5/245; B32B 2605/00

(57) ABSTRACT

The present invention relates to a novel process for the production of novel fibre-reinforced profile materials comprising a PMI foam core. In particular, the present invention relates to a novel pultrusion process, the abbreviated term used for which is pul-core process, which uses a single step for production of the fibre-reinforced profile material with simultaneous charging of the PMI foam core thereto. The same step here ensures very good linkage of the PMI foam core to the fibre-reinforced profile material.

### FIELD OF THE INVENTION

The present invention relates to a novel process for the production of novel fibre-reinforced profile materials comprising a PMI foam core. In particular, the present invention relates to a novel pultrusion process, the abbreviated term used for which is pul-core process, which uses a single step for production of the fibre-reinforced profile material with simultaneous charging of the PMI foam core thereto. The same step here ensures very good linkage of the PMI foam core to the fibre-reinforced profile material.

### PRIOR ART

According to the prior art, the process known as the in-mould process can be used to produce hollow bodies comprising PMI foams. A granulated material is charged to the finished hollow bodies here, and is then thermally foamed and, with this, crosslinked. A disadvantage of this process is that a plurality of steps are needed, namely the production of the hollow body, the charging of the granulated material, and the foaming. Another disadvantage is that because of the relatively high foaming temperature of the PMI it is impossible to use thermally unstable materials, an example being a composite made of carbon fibres and of an epoxy resin. Furthermore, the linkage brought about between foam and outer layer during the foaming process is only weak. This type of in-mould process is described by way of example in WO 2012/013393. In an alternative according to the prior art, PU foam in the form of liquid is injected into the cavity and then foamed and hardened. However, this process has attendant disadvantages similar to those of the process described using PMI foam, and it moreover cannot be converted for use with PMI.

An alternative possibility uses a cut-to-size foam core to fill open shell components, and a second shell component is then adhesive-bonded or welded to the first shell component to form the hollow profile. It is moreover possible to apply an adhesive layer at the interfaces in order to improve linkage of the foam core. Disadvantages of this process are that very many time-consuming steps are needed, that the final product has joints, and that the production of the foam core can, as a function of the shape of the same, produce a large amount of off-cut material.

In one variant, described in WO 2012/052219, the foam core is inserted together with a woven material—e.g. carbon fibres—within a mould and the resin—e.g. epoxy resin—is injected into the said mould and hardened. Although, on the one hand, joints are avoided here, on the other hand this process has the same disadvantages as the process described above in respect of off-cut material, process speed and complication.

The pultrusion process is an established process that derives from initial developments at the beginning of the 1950s. The pultrusion process is used to produce continuously fibre-reinforced plastics profiles, among which are also by way of example hollow profiles, in particular pipes. In the original method here, a polyester resin or an epoxy resin was used to impregnate a plurality of glass fibres (glass rovings), and these were then brought together by way of one or more shaping moulds to give the final shape. Finally, the resin is hardened, and the continuously produced profile is sawn into sections to give individual workpieces.

### OBJECT

The object underlying the present invention was primarily to provide a novel process for the production of fibre-reinforced hollow profiles comprising a PMI foam material, examples of these profiles being pipes.

In particular, it was an object of the present invention to provide a process which permits very good linkage between foam core and exterior layers. A further intention is that the process according to the invention can also use, as outer material, materials that cannot be exposed to the foaming temperature of the PMI.

Another object was that the process can be carried out rapidly, in a small number of steps and at low cost. In particular, it would be advantageous if the process can be executed on existing plants with minimal modifications.

Another object was continuous conduct of the process.

Another object of the present invention was to provide novel hollow profiles comprising a PMI foam and having a) no adhesive layer between the PMI foam core and the outer material of the hollow profile, b) no joints and c) good bonding between outer material and PMI foam core. A particular object here was to provide hollow profiles whose outer material is composed of a fibre material bonded with a polymer resin, and whose core is composed of a PMI foam core, where the pore size and therefore the density of the foam core, can be adjusted flexibly.

Further objects can be apparent from the description, from the drawings and from the examples without being explicitly mentioned here.

### ACHIEVEMENT OF OBJECT

The objects are achieved by means of a novel process for the continuous production of fibre-reinforced continuous profiles comprising a PMI foam core. This process involves a pultrusion process in which a foam core made of PMI is introduced in the centre. Furthermore, an outer layer made of a fibre material and of a thermoplastic or of a thermoset is formed around the said foam core by means of the pultrusion process. This novel pultrusion process with introduction of a PMI foam core into a pultrusion product is hereinafter termed pul-core process.

The pultrusion process involves a process in which, in a first step, a plurality of fibres or rovings are saturated with a resin. A distinction is made here between what is known as an open pultrusion process in which the said resin saturation takes place in a saturation trough through which the fibres are passed and a closed process in which the saturation with the resin takes place only when the material has reached the actual shaping instrument, under pressure. The plants generally have, upstream of the saturation process, devices such as carding grids, by means of which the fibres are distributed in a manner that is necessary for the subsequent shaping process, and optionally provided rovings can be broken up to give individual fibres. Another possibility is to use non-wovens, wovens and/or laid scrims as fibre material as an alternative to, or a supplement to, rovings or fibres.

After the saturation of the fibre material with the resin, this is then subjected to a preforming process by means of one or more moulds; in the integrated process, this takes place simultaneously. The said preforming process can by way of example use one or more mould cuffs. According to the invention, the fibre material here is conducted around the foam core that has been separately introduced, and that has preferably not been introduced via the saturation trough, the result being that, prior to entry into the actual shaping mould, the fibre material surrounds this core.

Within the shaping mould, the final shaping, the hardening of the resin, and a calibration process take place simultaneously with one another. In the shaping process it is possible that the fibres lie parallel to one another, orientated in the direction of processing around the foam core. However, it is preferable that the fibres form a woven structure around the foam core. This embodiment achieves particular mechanical strength of the subsequent workpiece.

The hardening of the resin, which can also be termed reinforcing material, generally takes place thermally. The temperature used for this purpose in the shaping mould depends on the resin used on each occasion, and can easily be determined by the person skilled in the art. These temperatures are generally from 100 to 200° C. Care has to be taken here to provide uniform temperature distribution within the mould, in order to ensure that workpieces are uniformly hardened.

The shaping mould is generally followed by a device for cooling the finished hollow profile.

If the resin does not involve a subsequent thermoset, but instead involves a thermoplastic material, another alternative possibility is that the resin is applied at a temperature above the melting point or glass transition temperature to the fibres, and the “hardening” takes place within the shaping mould, with cooling.

The transport of the fibres is generally achieved by applying tension to the continuous profile at the end of the plant, e.g. via a caterpillar take-off or via reciprocating hydraulic grippers.

A great advantage of this shaping process is that it can be achieved continuously, and that a continuous profile is initially obtained. A fully automatic procedure at the end of the plant saws this continuous profile into individual workpieces of desired length.

This novel pul-core process can produce various types of continuous profiles. The profiles can have one or more chambers. Profiles with a chamber can by way of example take the form of round pipe or else of rectangular or square profile comprising chambers. It is also possible to produce continuous profiles with complex shape, i.e. with two, or a plurality of, variously shaped or variously dimensioned chambers. Round pipes can by way of example not only have a simple round shape, with round foam core and round jacket, but can also by way of example have a round foam core and a polygonal jacket, or a polygonal foam core and a round jacket. Irrespective of the shape and the number of chambers, the continuous profile can be produced with different wall thicknesses and/or foam core dimensions.

The workpieces according to the invention have very good mechanical properties, in particular in respect of very good stiffness values relating to indentation, to buckling, and to compression. They also exhibit particularly high compressive strengths and increased energy absorption on impact, and when they are used in automobile construction they therefore contribute to an improvement in bodywork stability, for example in the event of a crash. In bodywork they can moreover, when compared with metal components, in particular with hollow structures comprising no fill, they can improve acoustics, i.e. reduce noise generated via the chassis.

There are a number of variants of the pultrusion process, some of which can be converted for use in the pul-core process according to the invention, via additional introduction of a foam core.

The pul-preforming process uses prefabricated preforms made of fibre material, in order to give the profile the necessary properties. This in particular leads to higher multidirectional strength values. The term preforms here means defined wovens, laid scrims, tubes or other prefabricated dry preforms which are bonded to the matrix material by means of injection or of saturation through immersion in the continuous process. In this variant of the process, the foam core can be introduced during production of the preforms. The saturation with the resin is correspondingly achieved on the preform comprising the foam core. By virtue of the closed pore structure of the PMI foam material, resin enters only open pores present at the external surface.

The pul-winding process is similar to traditional pultrusion. However, by virtue of rotating winding devices in this process, the reinforcing fibres are at different angles when they are coated by the matrix and then hardened in a shaping mould. This technology makes it possible to comply with particularly stringent loading requirements placed upon pipes, bars and other profiles. This process can be designed with different rotating angles. The angles can generally be adjusted from 0° to 85°. The resin-saturated fibre material here surrounds, and is wound around, the foam core.

The pul-braiding process involves a variant of the pul-winding process in which it is possible to process a plurality of different layers of fibre material in a braid structure.

The selection of the suitable fibre material poses no problem to the person skilled in the art, since the fibre materials that can be processed are known from established pultrusion technology. It is preferable that the fibre material involves carbon fibres, glass fibres, polymer fibres, in particular aramid fibres, or textile fibres, particularly preferably aramid fibres or carbon fibres.

The same applies to the matrix material, for which it is possible to use any thermoplastic suitable for the pultrusion process or any resin that is suitable for the pultrusion process and that can be reacted after crosslinking to give a thermoset. Preference is given to the resins mentioned that can be reacted to give a thermoset. In particular, these involve the following resins: polyester, vinyl ester, phenolic, PU or epoxy, and they particularly preferably involve PU resins or epoxy resins.

According to the invention, the material used for the foam core is poly(meth)acrylimide, abbreviated to PMI in this text. “(Meth)acryl-” here means methacryl-, acryl- or a mixture of the two. PMI foams of this type are normally produced in a two-stage process: a) production of a cast polymer and b) foaming of the said cast polymer.

The cast polymer is produced by first producing monomer mixtures which comprise (meth)acrylic acid and (meth)acrylonitrile as main constituents, preferably in a molar ratio of from 2:3 to 3:2. Further comonomers can also be used, examples being esters of acrylic or methacrylic acid, styrene, maleic acid or itaconic acid and, respectively, anhydrides thereof, or vinylpyrrolidone. However, the proportion of the comonomers here should not be more than 30% by weight. It is also possible to use small amounts of crosslinking monomers, e.g. allyl acrylate. However, the amount should preferably be at most from 0.05% by weight to 2.0% by weight.

The copolymerization mixture also comprises blowing agents which at temperatures of about 150 to 250° C. either decompose or evaporate and thus form a gas phase. The polymerization process takes place below this temperature, and the cast polymer therefore comprises a latent blowing agent. The polymerization process advantageously takes place in the form of a slab between two glass sheets.

The cast polymer is then foamed in a second step at appropriate temperature. The production of PMI foams of this type is known in principle to the person skilled in the art and can by way of example be found in EP 1 444 293, EP 1 678 244 or WO 2011/138060.

The foam components needed as core material for the pul-core process can either be produced via a production process which uses the in-mould-foaming process described at an earlier stage above, or else preferably can be cut, sawn or milled from foam sheets. It is preferably possible here to cut a plurality of foam components from one sheet. In one particular alternative, it is also possible that the off-cut material from the production of relatively large PMI foam components, for example as used in aircraft construction or in the production of wind turbines, is optionally used after further cutting.

It is preferable that material used for the foam core comprises PMI foams in the density range from 30 to 200 kg/m³. Particular PMI foams that may be mentioned are ROHACELL® grades from Evonik Industries AG.

An advantage of sawn, cut or milled foam core sections over sections produced by means of in-mould foaming is that these have open pores at the surface. On contact with the resin-saturated fibres, some of the not yet hardened resin penetrates into the said open pores at the foam core surface. This has the advantage of giving particularly strong adhesion at the interface between foam core and jacket material after hardening.

Since, unlike the fibre material, the foam core cannot be provided on rolls with several hundred metres of material, this is preferably conducted continuously in the form of a plurality of successive individual sections into the pultrusion plant. This can be achieved manually or, in particular with standardized-length foam sections, by automation.

The present invention provides not only the said process but equally novel hollow profiles, composed of one or more PMI foam cores and of a jacket material which has been formed from a fibre material and from a matrix material. The information provided above in relation to the process applies equally to the materials used here. The matrix material preferably involves a thermoset, in particular a hardened epoxy resin or hardened PU resin. The fibre material in particular involves carbon fibres or glass fibres.

A particular feature of this type of hollow profile according to the invention, comprising a PMI foam, is that the outer material involves thermoset reinforced with a fibre material and that the foam core involves a PMI foam, and that the hollow profile comprising PMI foam has no adhesive layer and no joints.

This type of novel hollow profile with a PMI foam core has great advantages over the prior art. The lack of joints contributes to uniform mechanical load-bearing capability and to increased overall stability of the hollow profile. The lack of adhesive layers contributes to weight savings and to markedly greater ease of production, with at least comparable mechanical load-bearing capability.

In one particular embodiment, the PMI foam can comprise a further material made of metal or of another plastic embedded within the foam material. The said material can by way of example take the form of a tube. This type of tube can by way of example function as cable duct in the use in bodywork construction.

In addition, or irrespective thereof, the PMI foam can have inserts, in particular metallic inserts. Inserts of this type subsequently serve as connection points for the component during their use by way of example in automobile construction or aircraft construction. An example of an insert that can be introduced here is a metal block, into which a screw thread can then be introduced by a milling process, and can then subsequently be used for a screw connection.

The hollow profiles according to the invention with a PMI foam core, or the hollow bodies produced by the process according to the invention and having a PMI foam core, are versatile. Although this description is not in any way to be interpreted as restricting, a primary concern here is directed to light-weight construction. This applies in particular to automobile construction, commercial vehicle construction, shipbuilding, aircraft construction, and helicopter construction, to the construction of installations for obtaining energy from wind, and to space travel. In automobile construction, particular mention may be made of the construction of crumple zones, e.g. in the form of what is known as a crash box in the frontal region of an automobile. In this type of use, the hollow profiles according to the invention, embedded into an appropriate matrix, e.g. again within a PMI foam matrix, represent an alternative that is almost equivalent to aluminium or steel in mechanical terms while, however, having markedly lower weight.

### KEY TO THE DRAWINGS

FIG. 1 shows by way of example a diagram of a plant suitable for the pul-core process according to the invention. The key to FIG. 1 follows:

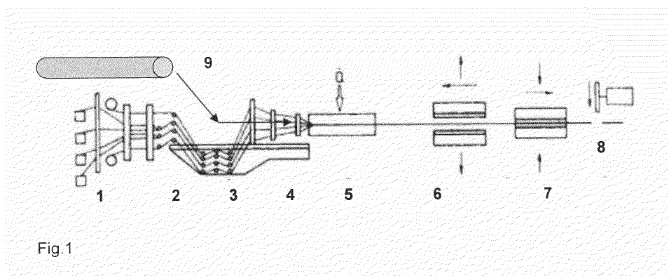

1 Untreated fibres are brought together

2 Rovings are separated and fibres are orientated

3 The untreated fibres are impregnated/saturated with a product-specific resin formulation in the saturation trough

4 A mould cuff is used to preform the strand

5 Shaping, hardening and calibration take place in the heated mould

6 Cooling section

7 Tension

8 Separation by means of a saw

9 Introduction of the foam core

1. A process for the continuous production of fibre-reinforced continuous profiles comprising a PMI foam core, the process comprising performing a pultrusion process in which a foam core comprising PMI is introduced in a centre and, by means of the pultrusion process, an outer layer comprising a fibre material and a thermoplastic or a thermoset is formed around the the core.

2. The process according to claim 1, comprising introducing the foam core continuously in the form of a plurality of successive individual pieces into a pultrusion plant.

3. The process according to claim 1, wherein the fibre material comprises carbon fibres, glass fibres, polymer fibres, or textile fibres.

4. The process according to claim 1, wherein the thermoset comprises a material comprising one of the following resins: polyester, vinyl ester, phenolic, PU or epoxy resin.

5. The process according to claim 1, wherein the fibre material is in the form of individual fibres, rovings, non-wovens, wovens, laid scrims, or any combination thereof.

6. The process according to claim 1, wherein PMI foams in a density range of from 30 to 200 kg/m³ are employed as material for the PMI foam core.

7. The process according to claim 1, wherein the pultrusion process comprises one of the following processes around the introduced foam core: modified pul-preforming, pul-winding or pul-braiding.

8. A hollow profile, comprising PMI foam, a foam core and an outer material, wherein the outer material comprises a thermoset reinforced with a fibre material and the foam core comprises the PMI foam, and wherein the hollow profile comprising the PMI foam has no adhesive layer and no joints.

9. The profile comprising PMI foam, according to claim 8, wherein at an interface between PMI foam core and a jacket material, the PMI foam core has open pores comprising a matrix material.

10. The profile according to claim 8, wherein the thermoset comprises a hardened epoxy resin or hardened PU resin, and the fibre material comprises carbon fibres or glass fibres.

11. The profile according to claim 8, wherein the PMI foam comprises a further material comprising metal or another plastic, optionally in the form of a tube.

12. The profile according to claim 8, wherein the PMI foam has inserts.

13. The profile according to claim 8, wherein the profile is suitable for automobile construction, commercial vehicle construction, shipbuilding, aircraft construction, and helicopter construction, in the construction of installations for obtaining energy from wind, and in space travel.
